(19) United States
(12) Patent Application Publication
(10) Pub. No.: US 2014/0359105 A1
(43) Pub. Date: Dec. 4, 2014

(54) METHOD, CLIENT, SERVER, AND SYSTEM FOR PROCESSING DATA

(71) Applicant: TENCENT TECHNOLOGY (SHENZHEN) COMPANY LIMITED, Shenzhen (CN)

(72) Inventors: Donglin PU, Shenzhen (CN); Zhenyu YU, Shenzhen (CN); Junming ZHENG, Shenzhen (CN); Lanqi SONG, Shenzhen (CN)

(73) Assignee: TENCENT TECHNOLOGY (SHENZHEN) COMPANY LIMITED, Shenzhen (CN)

(21) Appl. No.: 14/340,889

(22) Filed: Jul. 25, 2014

Related U.S. Application Data
(63) Continuation of application No. PCT/CN2014/077426, filed on May 14, 2014.

(30) Foreign Application Priority Data
Jun. 3, 2013 (CN) 201310216210.X

(51) Int. Cl. H04L 12/823

(52) U.S. Cl. CPC H04L 47/323
USPC 709/223

(57) ABSTRACT

A method for processing data is provided. In the method, the terminal device receives a blocking command to screen out a specified user identification.

The terminal device sends a blocking request comprising the specified user identification to the server so that the server screens out at least one data packet comprising the specified user identification when sending data packets to the terminal device. Accordingly, the embodiment of the present disclosure also provides corresponding clients, servers and systems.

### CROSS-REFERENCE TO RELATED APPLICATIONS

This application is a continuation of International Application No. PCT/CN2014/077426, filed on May 14, 2014, which claims priority to Chinese Patent Application No. 201310216210.X, filed on Jun. 3, 2013, both of which are incorporated herein by reference in their entireties.

### FIELD

This disclosure relates to Internet application technologies, specifically involves a method, client, server, and system for processing data.

### BACKGROUND

At present, there are many users prefer to use multiplayer voice chat tool when playing games. After entering a virtual room, all users in the room can hear each other's talk as long as any one of the users is speaking. However, personal quality of different users varies and some users often speak rudely. This may cause distress to some users. If enable the mute function so as not to hear the rude language, all users within the room will be muted and result that nothing can be heard from other users.

The inventor of the present disclosure found that the reason for this problem in the existing technology is that the server offering data relay for clients is incapable of filtering the undesired data that users do not want to receive.

### SUMMARY

The embodiment of the present disclosure provides a data processing method to screen out the undesired data that users do not want to receive. The embodiment of the present disclosure also provides relevant clients, servers and systems,

In a first aspect, the present disclosure provides a data processing method. The method is implemented by a terminal device having a processor.

The terminal device receives a blocking command to screen out a specified user identification. The terminal device sends a blocking request comprising the specified user identification to the server so that the server screens out at least one data packet comprising the specified user identification when sending data packets to the terminal device.

In the first possible implementation mode in the first aspect, when sending blocking request which comprises the specified user identification to the server, the server screens out the data packet comprising the specified user identification when sending data packet to the client where the blocking request is from. The step of this process includes:

In a second aspect, the present disclosure provides a data processing method implemented by a server. The server receives a blocking request from a terminal device, the blocking request comprising a specified user identification. The server receives and resolves, by the server data packets sent from multiple terminal devices under the control of server where each data packet comprising a corresponding user identification. When a resolved data packet comprising the specified user identification, the server screens out the resolved data packet to the terminal device.

In a third aspect, the present disclosure provides a client device. The client device includes: a first receiving unit and a transmit unit. The first receiving unit is configured to receive the blocking command input by user to screen out the specified user identification. The transmit unit is configured to send blocking request which comprises the specified user identification to the server, and the server screens out the data packet comprising the specified user identification when sending data packet to the client where the blocking request is from.

In a fourth aspect, the present disclosure provides a server which includes a second receiving unit, a processing unit, and a blocking unit. The second receiving unit is configured to receive the blocking request comprising specified user identification from client, and receive the data packets sent from multiple clients under the control of server; the stated data packet comprises relevant user identification of each data packet. The processing unit is configured to resolve each data packet received from the second receiving unit. The blocking unit is configured to, when data packet comprising the specified user identification is resolved out, screen out this resolved data packet when sending data packet to the client where the blocking request is from.

### BRIEF DESCRIPTION OF THE DRAWINGS

To better explain the technical scheme of the present disclosure, the accompanying drawings necessary for the illustration of example embodiments of the disclosure are briefly described below, and it is apparent to those of ordinary skill in the art that the accompanying drawings only illustrate some embodiments of the disclosure and that other drawings may be obtained according to the accompanying drawings without any innovative efforts.

FIG. 1 is a flow diagram for data processing method of an example embodiment of the present disclosure;

FIG. 2 is a flow diagram for data processing method of an example embodiment of the present disclosure;

FIG. 3 is a flow diagram for data processing method of an example embodiment of the present disclosure;

FIG. 4 is a flow diagram for client of an example embodiment of the present disclosure;

FIG. 5 is a flow diagram for server of an example embodiment of the present disclosure;

FIG. 6 is a flow diagram for server of an example embodiment of the present disclosure;

FIG. 7 is a flow diagram for server of an example embodiment of the present disclosure;

FIG. 8 is a flow diagram for server of an example embodiment of the present disclosure;

FIG. 9 is a flow diagram for client of an example embodiment of the present disclosure;

FIG. 10 is a flow diagram for server of an example embodiment of the present disclosure; and

FIG. 11 is a flow diagram for the data processing system of an example embodiment of the present disclosure.

### DETAILED DESCRIPTION OF THE DRAWINGS

For a better understanding of the aim, technical schemes and advantages of the present invention, example embodiments are described in detail in connection with the accompanying drawings as follows.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

An exemplary environment may include a server, a client, and a communication network. The server and the client may be coupled through the communication network for information exchange, such as sending/receiving identification information, sending/receiving data files such as splash screen images, etc. Although only one client and one server are shown in the environment, any number of terminals or servers may be included, and other devices may also be included.

The communication network may include any appropriate type of communication network for providing network connections to the server and client or among multiple servers or clients. For example, communication network may include the Internet or other types of computer networks or telecommunication networks, either wired or wireless. In a certain embodiment, the disclosed methods and apparatus may be implemented, for example, in a wireless network that includes at least one client.

In some cases, the client may refer to any appropriate user terminal with certain computing capabilities, such as a personal computer (PC), a work station computer, a server computer, a hand-held computing device (tablet), a smart phone or mobile phone, or any other user-side computing device having a processor. In various embodiments, the client may include a network access device. The client can be stationary or mobile.

A server, as used herein, may refer to one or more server computers configured to provide certain server functionalities, such as database management and search engines. A server may also include one or more processors to execute computer programs in parallel.

The embodiment of the present disclosure provides a data processing method to screen out the undesired data that users do not want to receive. For a better understanding of the aim, technical schemes and advantages of the present disclosure, example embodiments thereof are described in detail in connection with the accompanying drawings as follows.

The example embodiments are just some of the embodiments of this present disclosure rather than all of them. Based on the example embodiments in the present disclosure, all the other embodiments obtained by a person having ordinary skill in the art without any creative laboring shall be deemed as within the protective range of this present disclosure.

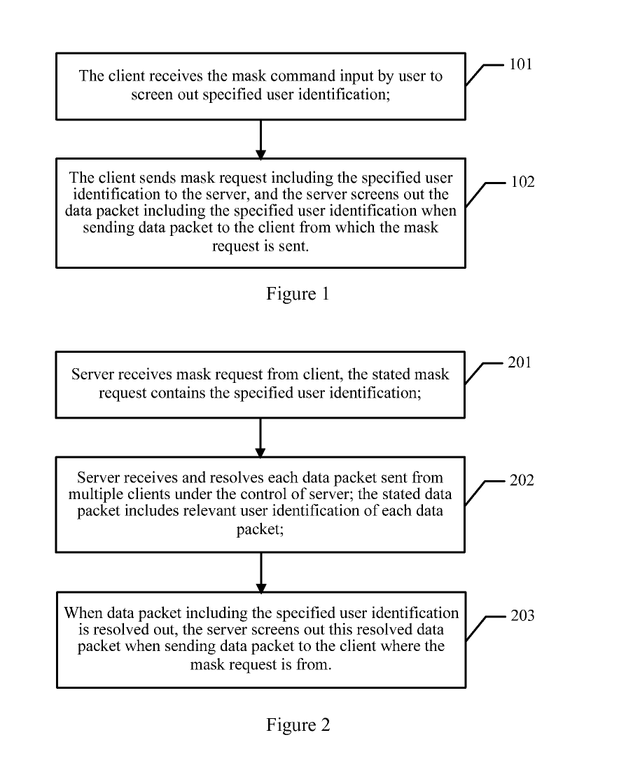

FIG. 1 shows an embodiment for the data processing method provided by the present disclosure includes:

101. The client receives the blocking command input by user to screen out specified user identification;

When a user is in a group chat using the multiplayer voice chat tool or playing games with multiple players online simultaneously, if he/she does not want to hear the talking of one of the users or does not want to receive data from any one of them, he/she can send blocking request comprising the user information of the specified user to the client.

102. The client sends blocking request which comprises the specified user identification to the server, and the server screens out the data packet comprising the specified user identification when sending data packet to the client where the blocking request is from.

In the embodiment of the present disclosure, the server receives the data packet sent from clients under the control of the server; the data packet comprises the user identification of the client where the data packet is from. After resolving the user identification and determining that the user identification included in the data packet is the one specified by the client, the server will not send the data packet to this client, that is, screen out the data packet comprising the specified user identification against this client.

For example: when user A wants to screen out user B's data, the client of user A sends blocking request which comprises the identification of user B to the server. After receiving the data packet comprising the identification of user B, the server will not send it to the client where the user A is located.

The present disclosure discloses a data processing method, including: receiving the blocking command input by user to screen out specified user identification; sending blocking request which comprises the specified user identification to the server, and the server screens out the data packet comprising the specified user identification when sending data packet to the client where the blocking request is from. Instead of always receiving undesired data from unwished users in the existing technology, the embodiment of the present disclosure provides a data processing method in which the undesired data can be screened out so that the user experience can be improved.

In another optional embodiment of the data processing method provided by the present disclosure, which is on the basis of the embodiment corresponding to FIG. 1, when sending blocking request which comprises the specified user identification to the server, and the server screens out the data packet comprising the specified user identification when sending data packet to the client where the blocking request is from, the step of screening out the data packet which comprises the specified user identification may include:

Sending a blocking request which comprises the specified user identification to the server, the server adds the specified user identification into the black list of the client where the blocking request is from, and matches the user identifications in received data packets with the one in the black list. If the user identification in the data packet is the one recorded in the black list, this resolved data packet is screened out when data packet is sent to the client where the blocking request is from.

In the embodiment of the present disclosure, after receiving a blocking request, the server adds the specified user identification in the request into the black list of the client where the blocking request is from and the back list may comprise specified user identification sent from this client; then the server compares the user identifications resolved from data packets with the one in the black list. If the user identification in the data packet is found from the black list, it indicates that this client wants to screen out the data packet comprising the specified user identification and the server will not send this very data packet to the client, that is, screen out the data packet comprising the specified user identification against this client.

In another optional embodiment of the data processing method provided by the present disclosure, which is on the basis of the embodiment corresponding to FIG. 1, the stated method also includes:

Receiving the command input by user to cancel the blocking to the specified user identification;

Sending a command to cancel the blocking request which comprises the specified user identification to the server, the server cancels the blocking to the data packet comprising the specified user identification when sending data packet to the client where the blocking cancelling request is from.

In embodiment of the present disclosure, when user A does not want to screen out user B's data any more, he/she can send blocking cancelling command to the client which will send the blocking cancelling request comprising the identification of user B to the server after receiving the command. The server will then cancel the blocking to the client of user A.

If there is a black list, user B will be removed from the black list.

FIG. 2 shows another embodiment for the data processing method provided by the present disclosure includes:

201. Receiving blocking request from client, the stated blocking request comprises the specified user identification;

202. The server receives and resolves each data packet sent from multiple clients under the control of server; the stated data packet comprises relevant user identification of each data packet;

202. When data packet comprising the specified user identification is resolved out, the server will screen out this resolved data packet when sending data packet to the client where the blocking request is from.

In the embodiment of the present disclosure, the server receives the data packet sent from clients under the control of the server, which comprises user identification. After resolving the user identification and determining that the user identification included in the data packet is the one specified by the client, the server will not send the data packet to this client, that is, screen out the data packet comprising the specified user identification against this client.

For example, when user A wants to screen out user B's data, the client of user A sends blocking request which comprises the identification of user B to the server. After receiving the data packet comprising the identification of user B, the server will not send it to the client where the user A is located.

In the embodiment of the present disclosure, receiving the blocking request sent from clients and the stated blocking request comprises specified user identification; receiving and resolving each data packet sent from multiple clients under the control of the server and the stated data packet comprises relevant user identification of each data packet. When data packet comprising the specified user identification is resolved out by the server, this resolved data packet is screened out when data packet is sent to the client where the blocking request is from. Instead of always receiving undesired data from unwished users in the existing technology, the embodiment of the present disclosure provides a data processing method in which the undesired data can be screened out so that the user experience is improved.

In another optional embodiment of the data processing method provided by the present disclosure, which is on the basis of the embodiment corresponding to FIG. 2, after the step of receiving blocking request which comprises the specified user identification from client, it also includes:

Adding the specified user identification into the black list of the client where the blocking request is from.

In the embodiment of the present disclosure, the server can set black list for the client sending blocking request. The black list may comprise the user identification specified by the client; after receiving the blocking request, the server can add the user identification in the blocking request into the black list.

Practically, the black list may not be limited to one client's blacklist. It is possible to set only one black list for all clients. In the blacklist, the mapping relation between the identification of clients which have sent blocking requests and the specified user identifications can be stored, so that after resolving data packet and finding in the black list the user identification included in the data packet, the server can determine not to send data packet comprising the specified user identification to which one or more clients based on the mapping relation.

In another optional embodiment of the data processing method provided by the present disclosure, which is on the basis of an optional embodiment corresponding to FIG. 2, after the step of resolving each data packet sent from multiple clients under the control of the server, it also includes:

The server device determines whether any resolved data packet comprises the specified user identification in the black list by matching the user identification in each data packet with the one in the black list.

In the embodiment of the present disclosure, if black list of each client is stored in the server, it can match the specified user identification with the blacklist in each client.

In another optional embodiment of the data processing method provided by the present disclosure, which is on the basis of the other embodiment corresponding to the above FIG. 2, the step that, when data packet comprising the specified user identification is resolved out, this resolved data packet is screened out when data packet is sent to the client where the blocking request is from, includes:

If at least one data packet whose user identification is the one recorded in the black list is found, this very data packet will be screened out when data packet is sent to the stated client.

In the embodiment of the present disclosure, if the user identification in a data packet is found from the black list, it indicates that this client wants to screen out the data packet comprising the specified user identification and the server will not send this very data packet to the client, that is, screen out the data packet comprising the specified user identification.

In another optional embodiment of the data processing method provided by the present disclosure, which is on the basis of an optional embodiment corresponding to FIG. 2, the stated method also includes:

Receiving blocking cancelling request from the client where the blocking request is from, the stated blocking cancelling request comprises the specified user identification;

Removing the specified user identification from the black list of the client where the blocking request is from.

In embodiment of the present disclosure, when user A does not want to screen out user B's data any more, he/she can send blocking cancelling command to the client which will send the blocking cancelling request comprising the identification of user B to the server after receiving the command. The server will then cancel the blocking to the client of user A.

In the embodiment of the present disclosure, if there is black list in the server, it will remove the mapping relation between the identification user A's client and the user B from the black list.

For ease understanding, the following section describes the process of data processing in the embodiment of the present disclosure by taking one application scenario.

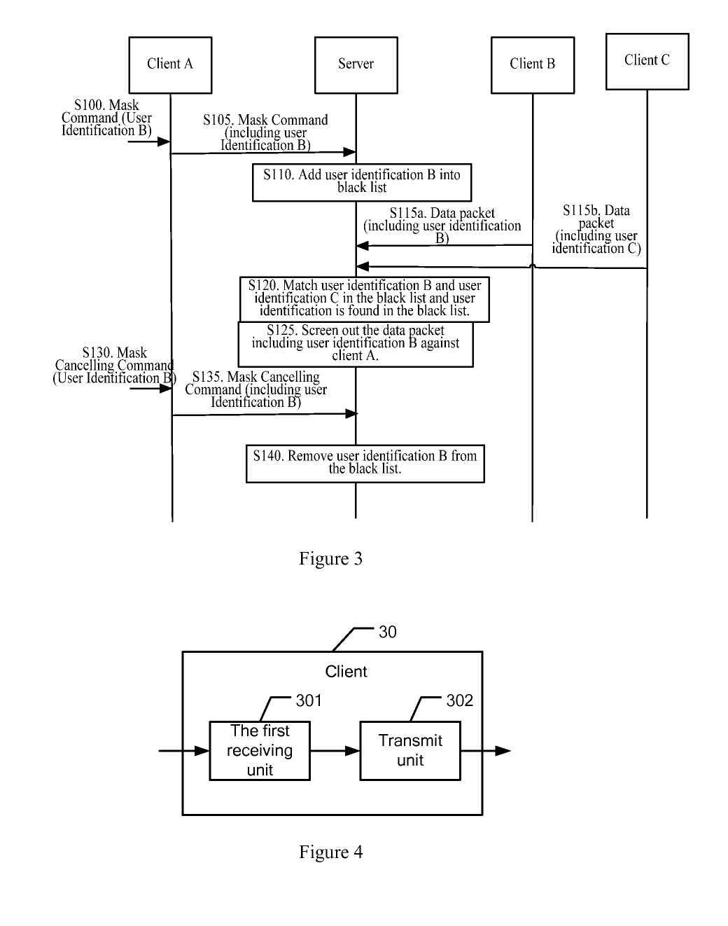

Please see FIG. 3, the method of data processing in the embodiment of the present disclosure includes:

S100. Client A receives the blocking command input by user to screen out user identification B;

S105. Client A sends blocking request to the server; the stated blocking request comprises user identification B.

S110. The server has been configured with Client A's blacklist; the server adds user identification B into Client A's blacklist.

S115a. The server receives the data packet comprising user identification B from Client B.

S115b. The server receives the data packet comprising user identification C from Client C.

S120. The server matches user identification B and user identification C in the black list and determines that user identification B is in the black list of Client A.

S125. When user identification B is matched, the server sends the data packet comprising user identification B to other clients, such as Client C, under the control of the server, and screens out the data packet comprising user identification B against Client A.

It can also be understood as not sending the data packet comprising user identification B to Client A.

If there is user identification B in black list of other clients, the data packet comprising user identification B will not be sent to these clients either.

S130. Client A receives the blocking cancelling command input by user to cancel the blocking to user identification B;

S135. Client A sends blocking cancelling request to the server; the stated blocking cancelling request comprises user identification B.

S140. The server removes user identification B from the black list of Client A.

Instead of always receiving undesired data from unwished users in the existing technology, the embodiment of the present disclosure provides a data processing method in which the undesired data can be screened out so that the user experience is improved.

Please see FIG. 4, an embodiment of Client 30 provided by the embodiment of the present disclosure includes:

The first receiving unit 301, configured to receive the blocking command input by user to screen out the specified user identification;

Transmit unit 302, configured to send blocking request which comprises the specified user identification to the server, and the server screens out the data packet comprising the specified user identification when sending data packet to the client where the blocking request is from.

In the embodiment of the present disclosure, the first receiving unit 301 receives the blocking command input by user to screen out specified user identification; transmit unit 302 sends the blocking request which comprises the specified user identification to the server, and the server screens out the data packet comprising the specified user identification when sending data packet to the client from which the blocking request is sent. Instead of always receiving undesired data from unwished users in the existing technology, the client provided in the embodiment of the present disclosure can screen out the undesired data that users do not want to receive so that the user experience is improved. In an optional embodiment for client provided by the embodiment of the present disclosure, which is on the basis of the embodiment corresponding to FIG. 4,

the stated transmit unit 302 is configured to send a blocking request which comprises the specified user identification to the server, the server adds the specified user identification into the black list of the client where the blocking request is from, and matches the user identifications in the received data packet with the one in the black list. If at least one data packet whose user identification is the one recorded in the black list is found, this resolved data packet is screened out when data packet is sent to the client where the blocking request is from.

In an optional embodiment of client provided by the embodiment of the present disclosure, which is on the basis of the embodiment corresponding to FIG. 4. The stated first receiving unit 301 is also configured to receive the command input by user to cancel the blocking to the specified user identification. The stated transmit unit 302 is also configured to send a blocking cancelling request which comprises the specified user identification to the server, the server cancels the blocking to the data packet comprising the specified user identification when sending data packet to the client where the blocking cancelling request is from.

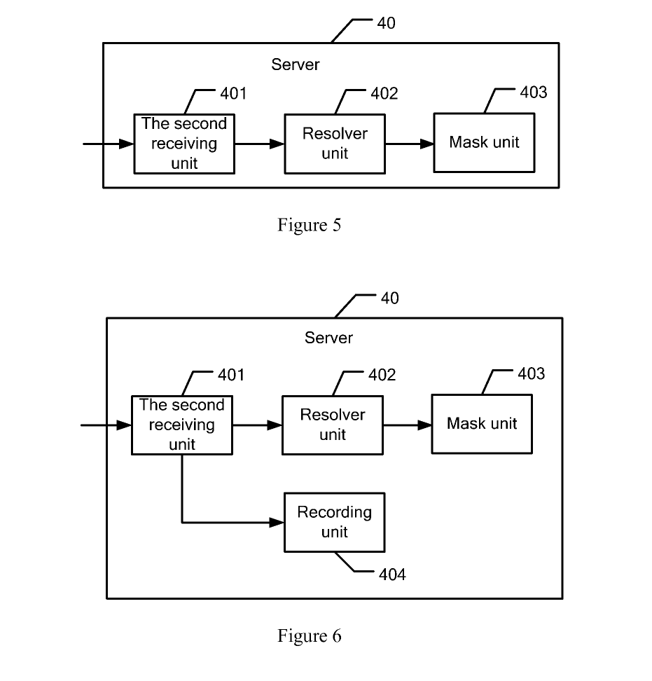

Please see FIG. 5, an embodiment for the server provided by the embodiment of the present disclosure includes:

The second receiving unit 401, configured to receive the blocking request comprising specified user identification from client, and receive the data packets from multiple clients under the control of server; the stated data packet comprises relevant user identification of each data packet;

Processing unit 402, configured to resolve each data packet received from the second receiving unit 401;

Blocking unit 403, configured to, when data packet comprising the specified user identification is resolved out by the stated processing unit 402, screen out this resolved data packet when sending data packet to the client where the blocking request is from.

In the embodiment of the present disclosure, the second receiving unit 401 receives the blocking request sent from clients and the stated blocking request comprises specified user identification; receives each data packet sent from multiple clients under the control of the server and the stated data packet comprises relevant user identification of each data packet. The processing unit 402 resolves the data packet received by the second receiving unit 402; the blocking unit 403, when data packet comprising the specified user identification is resolved out by the stated processing unit 402, screen out this resolved data packet when sending data packet to the client where the blocking request is from. Instead of always receiving undesired data from unwished users in the existing technology, the server provided in the embodiment of the present disclosure can screen out the undesired data that users do not want to receive so that the user experience is improved.

Please see FIG. 6, another embodiment of the server provided by the embodiment of the present disclosure, which is on the basis of the embodiment corresponding to FIG. 5, the stated server also includes:

Recording unit 404, configured to add the specified user identification into the black list of the client where the blocking request is from.

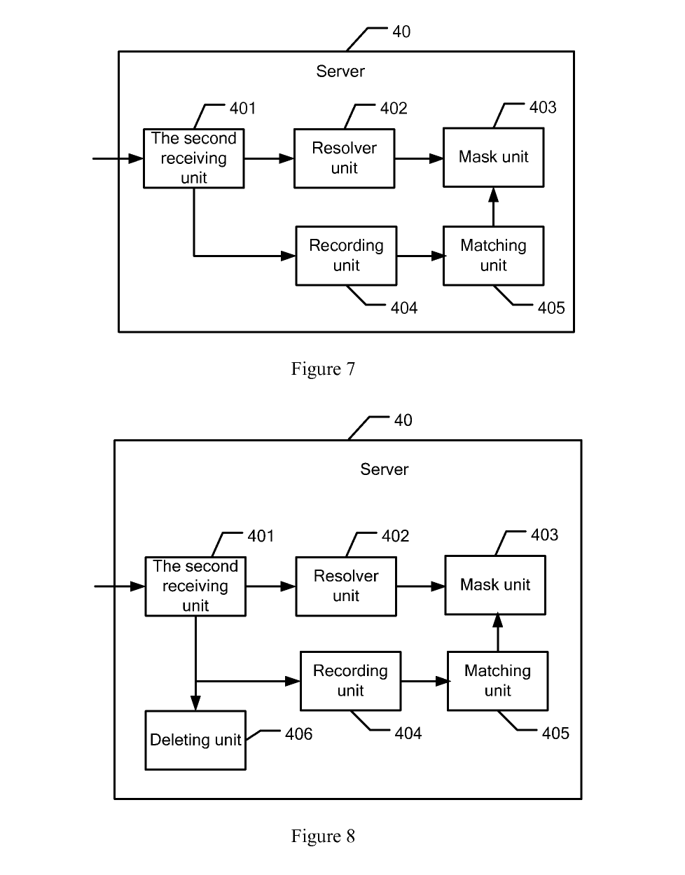

Please see FIG. 7, another embodiment of the server provided by the embodiment of the present disclosure, which is on the basis of the embodiment corresponding to FIG. 6, the stated server also includes:

Matching unit 405, configured to match the user identification in each data packet with the one in the black list stored in the recording unit;

In another embodiment of the server provided by the embodiment of the present disclosure, which is on the basis of the embodiment corresponding to FIG. 7, the stated server also includes:

Blocking unit 403, configured to, if at least one data packet whose user identification is the one recorded in the black list is found, screen out this very data packet when sending data packet to the stated client.

Please see FIG. 8, in another embodiment of the server provided by the embodiment of the present disclosure, which is on the basis of the embodiment corresponding to FIG. 6. The server may also include:

The second receiving unit 401, also configured to receive the blocking cancelling request from the client where the blocking request is from, the stated blocking cancelling request comprises the specified user identification;

Deleting unit 406, configured to remove the specified user identification from the black list of the client where the blocking request is from.

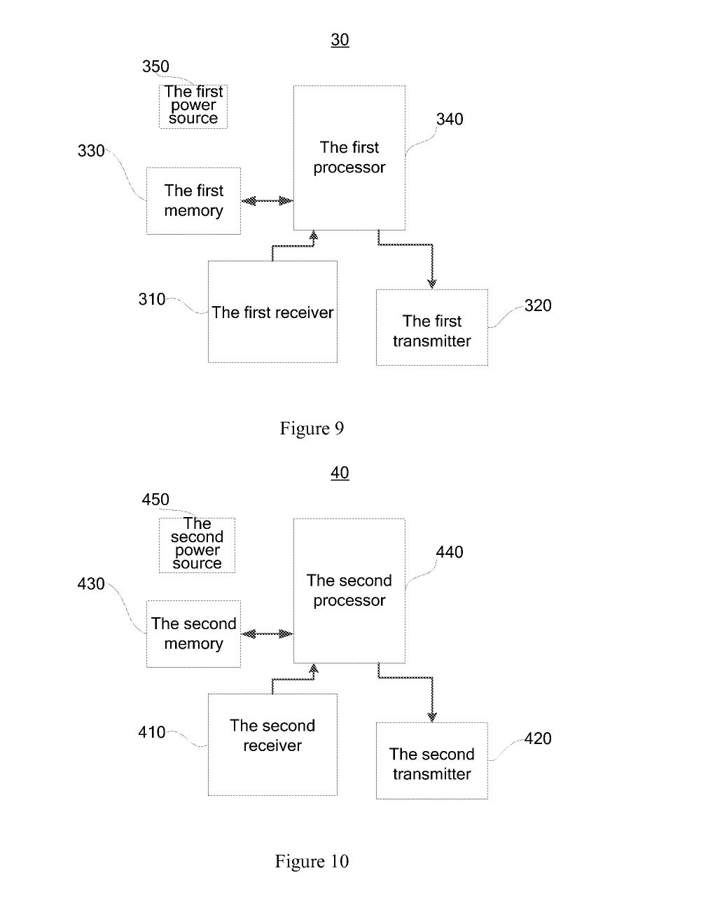

Please see FIG. 9, it shows the structure diagram of the second terminal involved in the embodiment of the present disclosure. This second terminal can be used to realize the data processing method provided in the above embodiment. To be specifically:

Please see FIG. 9, client 30 includes the first receiver 310, the first transmitter 320, the first memory 330 and the first processor 340, wherein the first receiver 310, the first transmitter 320, the first memory 330 and the first processor 340 are connected via a bus or other means;

The first memory 330 comprises one or more computer readable storage media. The stated first processor 340 may have at least one, and the stated client 30 may also include components such as power source 350. It can be understood by technical personnel in this field that what is shown in FIG. 9 does not constitute a limitation to client. It can include more or less components, or combine some of the components, or use different arrangement of components.

The first memory 330 may be used for storing software programs and modules; the first processor 340 executes various functional applications and data processing by running the software programs or modules stored in the first memory 330. The first memory 330 mainly includes the program storage area and data storage area, among which the program storage area can store the operating system and application programs needed for at least one function. Furthermore, the first memory 330 can also include the first high speed random access memory and the first nonvolatile memory, for instance, it can include at least one first disk storage device, flash memory, or other volatile solid-state first memory device. Accordingly, the first memory 330 may also include the first memory controller for the first processor 340 and the first receiver 310 to access to the first memory 330.

The first processor 340 is the control center of client 30. All of the parts of client 30 are connected through various kinds of interfaces and lines. The first processor 340 executes various functions and data processing of proxy server by running or executing the software programs or modules or calling the data stored in the first memory 330. Optionally, the first processor 340 may include one or more processing cores; however, it is preferred to integrate the first application processor and the first modem processor into the first processor 340.

Client 30 also includes the first power source 350 (such as batteries) which is for supplying power to various components, preferably, the power source can be logically connected to the first processor 340 via the power management system, and thus achieving the purpose of managing charging, discharging, and power consumption. The first power source 350 may also include one or more DC or AC power modules, recharging systems, power failure detection circuits, the power converters or inverters, power status indicators and other components.

Wherein, the first receiver 310 is configured to receive the blocking command input by user to screen out the specified user identification;

The first transmitter 320 is configured to send blocking request which comprises the specified user identification to the server, and the server screens out the data packet comprising the specified user identification when sending data packet to the client where the blocking request is from.

In some embodiments of the present disclosure, the first transmitter 320 is configured to send a blocking request which comprises the specified user identification to the server; the server adds the specified user identification into the black list of the client where the blocking request is from, and matches the user identifications in each the received data packet with the one in the black list. If at least one data packet whose user identification is the one recorded in the black list is found, this very data packet will be screened out when data packet is sent to the stated client where the mast request is from.

In some embodiments of the present disclosure, the first receiver 310 is also configured to receive the command input by user to cancel the blocking to the specified user identification;

The first transmitter 320 is also configured to send a blocking cancelling request which comprises the specified user identification to the server, and the server cancels the blocking to the data packet comprising the specified user identification when sending data packet to the client where the blocking cancelling request is from. On the other aspect, another embodiment of the present disclosure provides a computer-readable storage medium which may be the computer-readable storage medium included in the first memory of the above mentioned embodiment or alone that is not fitted into the terminal The stated computer-readable storage medium stores one or more programs and the one or more programs are used by one or more first processors to execute a data processing method, the said method includes:

Receiving blocking command input by user to screen out the specified user identification;

Sending blocking request which comprises the specified user identification to the server, and the server screens out the data packet comprising the specified user identification when sending data packet to the client where the blocking request is from.

Assume that the above is the first possible implementation mode, then in the second possible implementation mode which is based on the first possible implementation mode, when sending blocking request which comprises the specified user identification to the server, the server screens out the data packet comprising the specified user identification when sending data packet to the client where the blocking request is form, the step of screening out the data packet comprising the specified user identification includes:

Sending blocking request which comprises the specified user identification to the server, the server adds the specified user identification into the black list of the client where the blocking request is from, and matches the user identifications in the received data packet with the one in the black list. If at least one data packet whose user identification is the one recorded in the black list is found, this very data packet will be screened out when data packet is sent to the client where the blocking request is from.

In the third possible implementation mode which is based on the first and second possible implementation modes, the stated method also includes:

Receiving the command input by user to cancel the blocking to the specified user identification;

Sending a command to cancel the blocking request which comprises the specified user identification to the server, the server cancels the blocking to the data packet comprising the specified user identification when sending data packet to the client where the blocking cancelling request is from.

Please see FIG. 10, server 40 includes the second receiver 410, the second transmitter 420, the second memory 430 and the second processor 440, wherein the second receiver 410, the second transmitter 420, the second memory 430 and the second processor 440 are connected via a bus or other means;

The second memory 430 comprises one or more computer readable storage media. The second processor 440 may have at least one. The stated server 40 may also include components such as the second power source 450. It can be understood by technical personnel in this field that what is shown in FIG. 10 does not constitute a limitation to server. It can include more or less components, or combine some of the components, or use different arrangement of components.

The second memory 430 may be used for storing software programs and modules; the second processor 440 executes various functional applications and data processing by running the software programs or modules stored in the second memory 430. The second memory 430 mainly includes the program storage area and data storage area, among which the program storage area can store the operating system and application programs needed for at least one function. Furthermore, the second memory 430 can also include the second high speed random access memory and the second nonvolatile memory, for instance, it can include at least one second disk storage device, flash memory, or other volatile solid-state second memory device. Accordingly, the second memory 430 may also include the second memory controller for the second processor 440 and the second receiver 410 to access to the second memory 430. The second processor 440 is the control center of server 40. All of the parts of server 40 are connected via various kinds of interfaces and lines. The second processor 440 executes various functions and data processing of proxy server by running or executing the software programs or modules or calling the data stored in the second memory 430. Optionally, the second processor 440 may include one or more processing cores; however, it is preferred to integrate the second application processor and the second modem processor into the second processor 440.

Server 40 also includes the power source 450 (such as batteries) for supplying power to various components, preferably, the power source can be logically connected to the second processor 440 via the power management system, and thus achieving the purpose of managing charging, discharging, and power consumption. The second power source 450 may also include one or more DC or AC power modules, recharging systems, power failure detection circuits, the power converters or inverters, power status indicators and other components.

Wherein, the second receiver 410 is configured to receive the blocking request comprising specified user identification from client, and receive the data packets sent from multiple clients under the control of server; the stated data packet comprises relevant user identification of each data packet;

The second processor 440 is configured to resolve each data packet sent from multiple clients under the control of the server and the stated data packet comprises relevant user identification of each the data packet. When data packet comprising the specified user identification is resolved out, this resolved data packet is screened out when data packet is sent to the client where the blocking request is from.

In some embodiments of the present disclosure, the second processor 440 is also configured to add the specified user identification into the black list of the client where the blocking request is from.

In some embodiments of the present disclosure, the second processor 440 is also configured to match the user identification in each data packet with the one in the black list;

In some embodiments of the present disclosure, the second processor 440 is also configured to, if at least one data packet whose user identification is the one recorded in the black list is found, screen out this very data packet when sending the stated data packet to the stated client.

In some embodiments of the present disclosure, the second receiver 410 is also configured to receive the blocking cancelling request from the client where the blocking request is from, the stated blocking cancelling request comprises the specified user identification;

The second processor 440 is also configured to remove the specified user identification from the black list of the client where the blocking request is from.

On the other aspect, another embodiment of the present disclosure provides a computer-readable storage medium which may be the computer-readable storage medium included in the second memory of the above mentioned embodiment or alone that is not fitted into the terminal. The stated computer-readable storage medium stores one or more programs and the one or more programs are used by one or more second processors to execute a data processing method, the said method includes:

Receiving the blocking request comprising specified user identification from client, and receiving the data packets sent from multiple clients under the control of server; the stated data packet comprises relevant user identification of each data packet;

Resolving each data packet sent from multiple clients under the control of server; the stated data packet comprises relevant user identification of each data packet;

When data packet comprising the specified user identification is resolved out, this resolved data packet is screened out when data packet is sent to the client where the blocking request is from.

Assume that the above is the first possible implementation mode, then in the second possible implementation mode which is based on the first possible implementation mode, after the step of receiving the blocking request comprising specified user identification from client, it also includes:

Adding the specified user identification into the black list of the client from which the blocking request is sent.

Assume that the above is the second possible implementation mode, then in the third possible implementation mode which is based on the second possible implementation mode, after the step of resolving each data packet sent from multiple clients under the control of the server, it also includes:

Matching the user identification in each data packet with the one in the black list;

Assume that the above is the third possible implementation mode, then in the fourth possible implementation mode which is based on the third possible implementation mode, when data packet comprising the specified user identification is resolved out, this resolved data packet is screened out when data packet is sent to the client where the blocking request is from, the step of this process includes:

If at least one data packet whose user identification is the one recorded in the black list is found, this very data packet will be screened out when data packet is sent to the stated client.

Assume that the above is the second possible implementation mode, and then in the fifth possible implementation mode which is based on the second possible implementation mode, the stated method also includes:

Receiving blocking cancelling request from the client where the blocking request is from, the stated blocking cancelling request comprises the specified user identification;

Removing the specified user identification from the black list of the client where the blocking request is from.

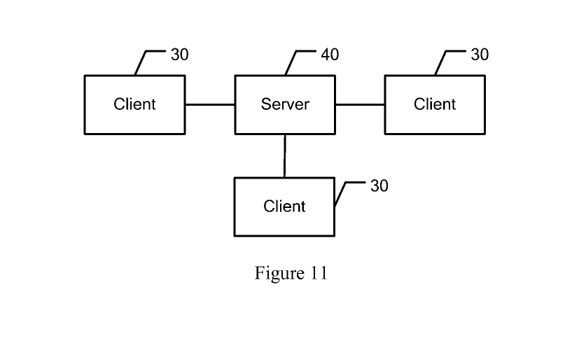

Please see FIG. 11, the embodiment of the present disclosure also provides a data processing system, including client 30 and server 40, and there may be over 30 clients which are not shown completely in the figure:

Client 30 is configured to receive the blocking command input by user to screen out specified user identification and send blocking request which comprises the specified user identification to the server, and the server screens out the data packet comprising the specified user identification when sending data packet to the client where the blocking request is from.

Server 40 is configured to receive the blocking request sent from clients and the stated blocking request comprises specified user identification; receive and resolve each data packet sent from multiple clients under the control of the server and the stated data packet comprises relevant user identification of each data packet; when data packet comprising the specified user identification is resolved out, screen out this resolved data packet when sending data packet to the client where the blocking request is from.

The present disclosure discloses a data processing method, including: receiving the blocking command input by user to screen out specified user identification; sending blocking request which comprises the specified user identification to the server, and the server screens out the data packet comprising the specified user identification when sending data packet to the client where the blocking request is from. Instead of always receiving undesired data from unwished users in the existing technology, the embodiment of the present disclosure provides a data processing method in which the undesired data can be screened out.

It is understood by the ordinary technicians of this field that all or part of the above embodiments can be completed through programs commanding relevant hardware and this program may be stored in a computer-readable storage medium, including ROM, RAM, disk, or compact disk, etc.

The above disclosed content is the detailed introduction to the data processing method, client, server and system provided by the embodiment of the present disclosure. This document elaborates the principle and implementation modes of the present disclosure using specific instances. The above elaboration to the embodiments is only for helping the understanding the method and core concept of the present disclosure. Meanwhile, ordinary technical staff in this field may make some changes in the specific implementation mode and application scope without departing from the concept of the present disclosure. In conclusion, the content of this document cannot be understood as a limitation to the scope of the present disclosure.

What is claimed is:

1. A method for processing data, comprising:
receiving, by a terminal device having a processor, a blocking command to screen out a specified user identification; and
sending, by the terminal device, a blocking request comprising the specified user identification to a server so that the server screens out at least one data packet comprising the specified user identification when sending data packets to the terminal device.

2. The method of claim 1, wherein sending the blocking request comprising the specified user identification to the server so that the server screens out at least one data packet comprising the specified user identification when sending data packets to the terminal device comprises:
sending the blocking request to the server so that the server adds the specified user identification into a black list of the terminal device and determines whether any received data packet comprises the specified user identification in the black list; and
blocking the data packet to the terminal device when the received data packet comprises the specified user identification in the black list.

3. The method of claim 1, further comprising:
receiving, by the terminal device, a cancel command to cancel the blocking request comprising the specified user identification; and
sending, by the terminal device, a cancel request comprising the specified user identification to the server so that the server cancels the blocking of the data packet comprising the specified user identification when sending data packet to the terminal device.

4. A method for processing data, comprising:
receiving, by a server having a processor, a blocking request from a terminal device, the blocking request comprising a specified user identification;
receiving and resolving, by the server, data packets sent from multiple terminal devices under control of the server; each data packet comprising a corresponding user identification; and
when a resolved data packet comprising the specified user identification, screening out the resolved data packet to the terminal device.

5. The method of claim 4, after the receiving the blocking request from the terminal device, the method further comprising:
adding, by the server, the specified user identification into a black list corresponding to the terminal device.

6. The method of claim 5, after resolving each data packet sent from multiple clients under the control of the server, the method further comprising:
determining, by the server, whether any resolved data packet comprises the specified user identification in the black list.

7. The method of claim 6, further comprising:
blocking, by the server, the data packet to the terminal device when the resolved data packet comprises the specified user identification in the black list.

8. The method of claim 5, further comprising:
receiving, by the server, a cancelling request from the terminal device, the cancelling request comprising the specified user identification; and
removing the specified user identification from the black list.

9. A server comprising a hardware processor and a non-transitory storage accessible to the hardware processor, the non-transitory storage comprising the following unites implemented by the hardware processor:
a receiving unit, configured to receive a blocking request comprising a specified user identification from a client, and receive data packets sent from multiple clients under control of the server; each data packet comprises a corresponding user identification of each data packet;
a processing unit, configured to resolve each data packet received from the receiving unit; and
a blocking unit, configured to screen out a resolved data packet to a terminal when sending the resolved data packet comprising the specified user identification.

10. The server of claim 9, further comprising:
a recording unit, configured to add the specified user identification into a black list of the client.

11. The server of claim 10, further comprising:
a matching unit, configured to match the user identification in each data packet with the one in the black list stored in the recording unit.

12. The server of claim 11, wherein the blocking unit is configured to screen out a data packet when sending data packet to the client if the data packet comprises the specified user identification in the black list.

13. The server of claim 10, further comprising:
a second receiving unit, configured to receive a cancelling request from the client where the blocking request is from, wherein the cancelling request comprises the specified user identification; and
a deleting unit, configured to remove the specified user identification from the black list of the client where the blocking request is from.
